(19) United States
(12) Patent Application Publication
(10) Pub. No.: US 2019/0114845 A1
(43) Pub. Date: Apr. 18, 2019

(54) METHOD AND SYSTEM FOR MOBILE DEVICES TO COMMUNICATE WITH SHIPPING PERIPHERAL DEVICES USING DISTRIBUTED INSTANCES OF CUSTOM HARDWARE

(71) Applicant: Pitney Bowes Inc., Danbury, CT (US)

(72) Inventors: Basant Ashok Mudalgi, Thane (West) (IN); Kiran Harichandra Bhangale, Pune (IN); Manish Sharma, Agra (IN); Shaishav Saraswat, Jabalpur (IN)

(73) Assignee: Pitney Bowes Inc., Danbury, CT (US)

(21) Appl. No.: 15/782,966

(22) Filed: Oct. 13, 2017

(51) Int. Cl. G07B 17/00; H04W 4/00; H04N 1/00; G06K 15/02; H04L 29/06

(52) U.S. Cl. CPC G07B 17/00508; H04W 4/008; H04N 1/00973; H04N 2201/0055; H04L 63/0428; H04N 2201/0082; G06K 15/1806

(57) ABSTRACT

A system and method for mobile devices that do not have hardware interfaces to be able to control shipping peripheral devices that are not connected directly thereto are provided. Intermediary hardware devices are utilized that are connected to a local area network. A first device communicates with the user's mobile device using very-short range communication protocols. A second device has the peripheral devices directly coupled thereto, and includes preinstalled drivers and application software for the peripheral devices. The devices allow the mobile device and peripheral devices to communicate with each other over the local area network. Thus, the mobile device can be used to control the peripheral devices even though the peripheral devices are not directly connected to the mobile device.

### FIELD OF THE INVENTION

The invention disclosed herein relates generally to systems and methods for dispensing evidence of payment for delivery of a mail piece, and more particularly to payment dispensing systems in which mobile devices communicate with peripheral devices to generate and dispense evidence of payment for delivery of a mail piece.

### BACKGROUND OF THE INVENTION

Payment metering systems generate encrypted information that is printed on a mail piece as part of an indicium evidencing payment for delivery of the mail piece. A mail piece can include any type of letter, flat, parcel, package or the like. The encrypted information includes a payment value for the mail piece combined with other data that relate to the mail piece and the meter printing the indicium. Since the indicium incorporates the encrypted information relating to the evidencing of payment, altering the printed information in an indicium is detectable by standard verification procedures.

The cost for delivery of some mail pieces, such as parcels, packages and the like, is typically dependent on the weight of the mail piece and/or the dimensions of the mail piece. As such, it is necessary to have a scale to provide the weight of the mail piece to the indicium generating application, and a dimension measuring device, such as a 3-D scanner or depth sensors, to provide the dimensions of the mail piece to the indicium generating application, which are then used to determine the cost. The generated indicium is then sent to a printing device for printing a label, which is adhered to the mail piece.

In current desktop postage generating systems, a software application or browser operating on a personal computer provides the functionality necessary to generate and print the evidence of payment. Peripheral devices necessary for generating and printing the indicium, e.g., a scale and printer, can be easily installed by making a physical connection to the computer. The devices can then be paired with the computer. Such pairing includes establishing a communication channel between the computer and the peripheral device, and installing any necessary drivers and/or native applications for the peripheral device. While this presents no issues for users of desktop devices, e.g., personal computers and the like, that are connected to the scale and printer directly or via a network where the user has the necessary permissions to install and execute drivers and support software, it does present problems for users of mobile devices, such as smartphones, tablets, and the like, that are unable to be physically connected to the peripheral devices or in environments where the user is a guest with reduced installation privileges. Thus, there is a need for a system and method for dispensing evidence of payment for delivery of a mail piece that allows mobile devices that do not have hardware interfaces to be able to control shipping peripheral devices that are not connected directly thereto.

### SUMMARY OF THE INVENTION

The present invention overcomes the problems associated with current payment evidencing systems by providing a system and method for mobile devices that do not have hardware interfaces to be able to control shipping peripheral devices that are not connected directly thereto. According to embodiments of the invention, two intermediary hardware devices are utilized that are connected to a local area network. The first device communicates with the user's mobile device using very-short range communication protocols or using mechanisms that ensure that the user has verifiable access to the device. The second device has the peripheral devices directly coupled thereto, and includes preinstalled drivers and application software for the peripheral devices. The intermediary devices allow the mobile device and peripheral devices to communicate with each other over the local area network. Thus, the mobile device can be used to control the peripheral devices even though the peripheral devices are not directly connected to the mobile device.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, by way of example serve to explain the invention in more detail. As shown throughout the drawings, like reference numerals designate like or corresponding parts.

FIG. 1 illustrates in block diagram form a system according to an embodiment of the present invention; and

FIG. 2 illustrates in flow diagram form the processing performed by the devices of the system of FIG. 1 according to an embodiment of the present invention.

### DETAILED DESCRIPTION OF THE PRESENT INVENTION

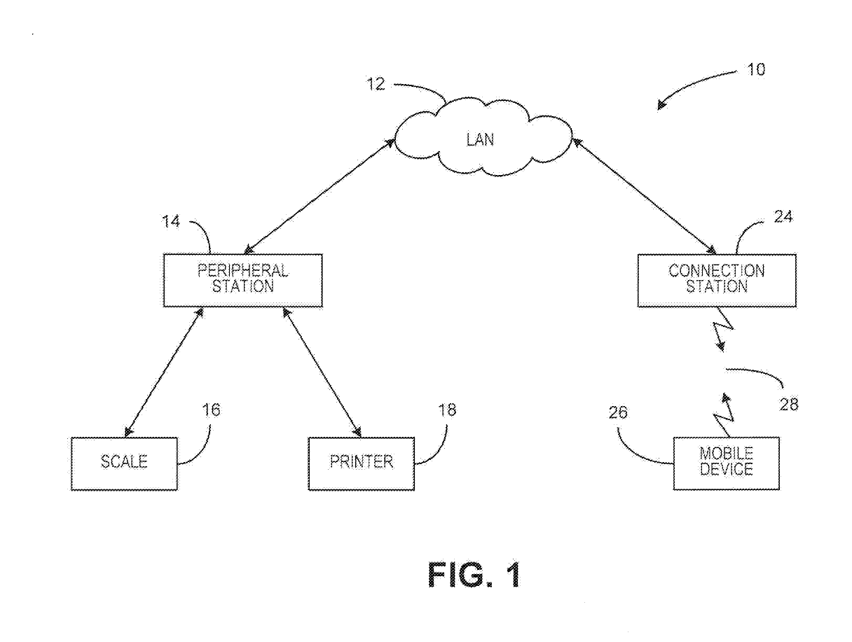

In describing the present invention, reference is made to the drawings, wherein there is seen in FIG. 1 a block diagram of a system 10 for generating and printing evidence of payment for delivery of a mail piece according to an embodiment of the present invention. Evidence of payment for delivery of a mail piece may also be referred to as “postage” herein without limiting such term to a postal service. It should be understood, therefore, that any reference to the term postage does not limit the invention to only postal services, and instead can also include any commercial or private carriers in addition to postal services. As described in greater detail below, the system 10 enables a user to generate and print evidence of payment for delivery of a mail piece using a mobile device to control shipping peripheral devices that are not connected directly thereto. It should be understood that the system 10 is just one particular embodiment of a postage dispensing system in which the present invention may be implemented, and that the invention as described herein may also be implemented in other configurations and/or embodiments.

The system 10 includes at least two intermediary devices, a peripheral station 14 and connection station 24, that are connected to a network, such as Local Area Network (LAN) 12. While FIG. 1 illustrates two intermediary devices, it should be understood that any number of intermediary devices could be provided. Preferably, for businesses and the like, a connection station 24 is provided in several work area locations, while a peripheral station 14 is provided at centralized locations where the peripherals devices attached thereto can be easily accessed by different people. A connection station 24 and peripheral station 14 can also be located in the same area. Peripheral station 14 includes a processing device and memory to run various software programs to control the operation of the peripheral station 14. Such processing device may be specially constructed for the required purposes, or it may comprise a general purpose processor selectively activated or reconfigured by computer programs stored therein. Peripheral station 14 preferably includes pre-installed drivers and application software, network communication software, and optionally location detection software (utilizing, for example, gps) that are stored in the memory. Peripheral station 14 also includes interfaces, such as, for example, universal serial bus (USB) ports, to allow physical connection with one or more peripheral devices, such as a scale 16 and printer 18, and physical connection with the LAN 12. Peripheral station 14 could also optionally include the capability for wireless communication, e.g., Bluetooth or other wireless network communication devices. While FIG. 1 illustrates two peripheral devices, it should be understood that the any number of peripheral devices could be included. The drivers and application software stored in the memory of peripheral station 14 allow the peripheral station 14 to drive the peripheral devices 16, 18. Preferably, station 14 also includes a mechanism to visually indicate which peripheral, e.g., scale 16 or printer 18, is being operated. Such mechanism could include, for example, an indicator light that is powered to indicate which peripheral is currently being operated. Peripheral station 14 can also query for and receive updates from a central internet server (not shown) that may be accessible via the LAN 12.

Connection station 24 includes a processing device and memory to run various software programs to control the operation of the connection station 24. Such processing device may be specially constructed for the required purposes, or it may comprise a general purpose processor selectively activated or reconfigured by computer programs stored therein. Connection station 24 includes a network interface to physically connect to a network, such as LAN 12. Connection station 24 further includes a short range communication device/interface that allows the connection station to communicate with a mobile device 26, such as, for example, Bluetooth, short-range wifi or the like, via a wireless connection 28. Mobile device 26 could be, for example, a smartphone, tablet, or other processing device upon which a postage generating application can operate to allow a user to generate evidence of payment for delivery of a mail piece. Utilizing the short range communication connection 28, the mobile device can communicate with the connection station 24, which in turn can communicate with the peripheral station 14, via LAN 12, to send and receive commands and responses required for the generation and printing of postage. Preferably, the peripheral station 14 acts as a server, and the connection station 24 acts as a client. Preferably, the connection station 24 continuously pings each device coupled to LAN 12 using standard protocols to discover any new peripheral stations 14 that have been added to the LAN 12. This avoids network broadcast protocols which are usually blocked by anti-virus software or some network switches. Once a communication station 24 has identified a peripheral station 14, the connection station 24 sends requests to the peripheral station 14 for information from a peripheral device connected to the peripheral station 14, e.g., weight from the scale 16, and sends commands to the peripheral station 14 to control a peripheral device connected to the peripheral station 14, e.g., print commands for the printer 18. Peripheral station 24 can also query for and receive updates from a central internet server (not shown) that may be accessible via the LAN 12. Utilizing the devices 16, 18 eliminates the need for any setup or installation on the mobile device 26 of any drivers or native applications necessary for operation of the peripheral devices 16, 18, thereby allowing the postage generation application to operate on any type of mobile device 26.

Preferably, to maintain security of the system 10, the peripheral station 14 and connection station 24 utilize one or more security protocols. For example, communications between the devices 16, 18 can be encrypted using standard communication encryption protocols. Secure authentication procedures can also be implemented to ensure that only authorized peripheral stations 14 and communications stations 24 are part of the system 10. Identification of authorized devices can be performed utilizing unique identification numbers assigned to each device. Additionally, security tokens can be stored in each device 16, 18 that can be utilized to authenticate a device using public key authentication mechanisms as are known in the art. Such security tokens can be generated and saved in the devices 16, 18 during manufacture of these devices, or generated after installation of the devices 16, 18 and paired together during an initial authentication procedure.

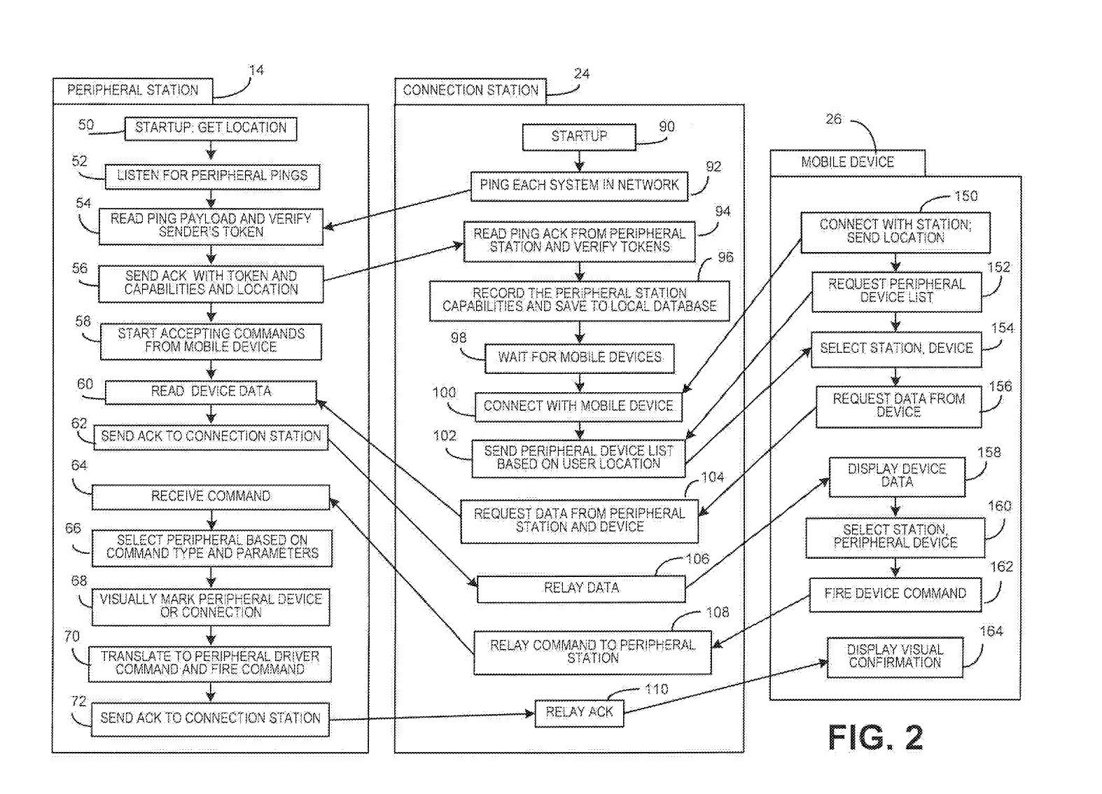

FIG. 2 illustrates in flow diagram form the processing performed by the devices of the system of FIG. 1 according to an embodiment of the present invention. In step 50, the peripheral station 14 performs a startup routine upon being powered and connected to the network 12. As part of this, the peripheral station 14 can optionally obtain its location for use as later described. In step 52, the peripheral station 14 will listen for pings that may be sent from any connection stations 24 that are connected to the network 12. In step 90, the connection station 24 performs a startup routine upon being powered and connected to the network 12. In step 92, the connection station 24 will send a ping to any peripheral station 14 that is also connected to the network 12. The ping preferably includes a request for each peripheral station 14 connected to the network 12 to provide the capabilities of any peripheral devices attached thereto, along with the location of the peripheral station 14. If security tokens are being utilized, the ping will also include the security token for the connection station 24. In step 54, upon the peripheral station 14 receiving the ping sent by the connection station 24 in step 92, then in step 54 the peripheral station 14 will read the ping payload, i.e., the contents of the ping. If a security token is provided, the peripheral station 14 will verify the connection station's 24 security token to ensure that the connection station 24 is an authorized device. In step 56 the peripheral station 14 will send an acknowledgement to the connection station 24 that includes the capabilities of the peripheral station 14, i.e., the peripheral devices attached thereto, and if security tokens are being used, a security token for the peripheral station 14.

In step 94, the connection station 24 receives and reads the acknowledgement sent from the peripheral station 14. If a security token is provided, the connection station 24 will verify the security token to ensure that the peripheral station 14 that responded is an authorized device. In step 96, the connection station 24 will record the information returned in the acknowledgement, i.e., the capabilities of the peripheral station 14, and store them in a local database. Upon each of the stations 14, 24 being authenticated to each other, the connection station 24 is now able to wait for communications with a mobile device 26 in step 98, while the peripheral station 14 is now able to start accepting commands from a mobile device 26 in step 58.

When a user desires to utilize an application being executed on the mobile device 26 to generate and print postage, in step 150 the user will have the mobile device 26 connect with the connection station 24 via a wireless connection 28 and send the location of the mobile device 26. As previously noted, such a connection can be made using, for example, Bluetooth, short-range wifi or the like. In some embodiments, the mobile device can establish a connection with the connection station 24 via an intermediary server over the Internet, using verification mechanisms such as QR codes, barcodes, passphrases and the like. The QR code/barcode/passphrase can be decoded into two parts: (1) a unique identifier representing the device (this can be a complete url or endpoint), and (2) a passkey for the mobile device 26 to identify itself as a legitimate device to the connection station 24. The strings of (1) and (2) may or may not be different based on desired security requirements. When using such verification mechanisms, the connection station 24 upon startup will register with a central server (which is known to all devices and applications). The central server creates a unique endpoint that represents the connection station 24 to pipe all information coming from and going to this particular connection station 24 through this end point. The user using the application running on the mobile device 26 scans the barcode/QR code (or can type in the passphrase) that is affixed on the connection station 24. The application decodes the barcode/QR code/passphrase into the endpoint of the connection station 26 and a passkey, and the application on the mobile device 26 starts communicating with the connection station 24 using the endpoint. Additionally the mobile application identifies/authenticates itself to the central server as a legitimate consumer using the passkey obtained from decoding the barcode/QR code/passphrase. Once the authentication is done, the intermediary server only acts as a relay station between the connection station 24 and mobile device 26.

In other embodiments, a similar procedure as the above can be used with the following exceptions. The connection station 24 itself starts acting as a server, and assigns to itself a .local domain (for instance, basestation.local) and starts waiting for a client communication. The mobile application running on the mobile device 26 decodes the QR code/barcode/passphrase into the .local address and communicates directly with this local address instead of connecting to a central server. The remaining process is similar to before except all communication happens directly between the connection station 24 and mobile device 26.

Returning again to FIG. 2, in step 100, the connection station 24 establishes a connection with the mobile device 26. In step 152, the mobile device 26 requests a peripheral device list from the connection station 24. In step 102, the connection station 24 will send to the mobile device 26 a list of peripheral stations 14, along with their attached peripheral devices, that are located near the mobile device 26 based on the location of the mobile device 26. The returned list can be displayed on a display of the mobile device 26, and in step 154 the user can then select a peripheral station 14 and one or more peripheral devices connected to that peripheral station 14 to obtain data about the capabilities of each of the peripheral devices. In step 156, the mobile device 26 requests data about the peripheral device(s) to determine the capabilities of the peripheral device(s). In step 104, the connection station 24 requests data for the selected peripheral device(s) from the peripheral station 14 selected by the user. In step 60 the peripheral station 14 will read the data from the selected peripheral device(s), and in step 62 send the read data back to the connection station 24. In step 106, the connection station 24 relays the data back to the mobile device 26, and in step 158 the data about the peripheral device(s) can be displayed on the mobile device 26.

In step 160, the user can select the peripheral station 14 and attached peripheral device desired to perform a service in the generation and printing of postage. For example, the user may desire that a specific scale coupled to a selected peripheral station 14 weigh the mail piece in order to generate a postage indicium, or the user may desire that a specific printer coupled to a selected peripheral station 14 print a generated postage indicium on a label. In step 162, the mobile device 26 fires a device command for the selected peripheral device which is sent to the connection station 24 via the wireless communication 28. In step 108 the connection station 24 relays the command to the appropriate peripheral station 14. In step 64, the peripheral station 14 receives the command, and in step 66 selects the peripheral device based on the command type and parameters of the command. In step 68, the peripheral device 14 can optionally visually mark the peripheral device that has been selected using, for example, an indicator light as described above. In step 70, the peripheral device 14 translates the received command into a driver command for the peripheral device and fires the command to the peripheral device for execution. Upon successful execution of the command by the peripheral device, the peripheral station 14 sends an acknowledgement of completion of the command to the connection station in step 24. In step 110, the connection station relays the acknowledgement to the mobile device 26, which in step 164 displays a visual confirmation that the command has been executed to the user.

If the device command in step 162 was for a scale to obtain a weight of a mail piece, then the return acknowledgement would also include the weight from the scale, which can then be used by the postage generating application running on the mobile device 26 to generate an indicium. The user can then request a printing device attached to the peripheral station 14 to print the generated indicium on a label.

Thus, by using the system 10 of the present invention, a user can generate and print evidence of payment for delivery of a mail piece using a mobile device to control shipping peripheral devices that are not connected directly thereto. While the above description was provided with respect to the generation and printing of postage, it should be understood that the present invention is not so limited and can be used in other applications where peripheral devices are required when using an application on a mobile device. Additionally, while preferred embodiments of the invention have been described and illustrated above, it should be understood that they are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A system for generating and printing postage using a mobile device, the system comprising:
a first intermediate processing device coupled to a network, the first intermediate processing device including a short range communication device for communicating wirelessly with the mobile device;
a second intermediate processing device coupled to the network, the second intermediate processing device including at least one physical connection interface;
a peripheral device coupled directly to the second intermediate processing device by the at least one physical connection interface, the second intermediate processing device storing a driver for the peripheral device coupled directly thereto;
wherein an application executing on the mobile device to generate and print postage can control the peripheral device without the mobile device being directly connected to the peripheral device by wirelessly communicating a command to control the peripheral device to the first intermediate processing device, sending the command from the first intermediate processing device to the second intermediate processing device via the network, and executing by the peripheral device under control of the driver stored by second intermediate processing device the command to perform a function associated with the generation and printing of postage.

2. The system of claim 1, wherein the peripheral device is a scale.

3. The system of claim 1, wherein the peripheral device is a printer.

4. The system of claim 1, wherein the second intermediate processing device is coupled to the network by a wireless connection.

5. The system of claim 1, wherein the second intermediate processing device includes an indicator light that lights when the peripheral device is being operated.

6. The system of claim 1, wherein the first intermediate processing device encrypts the command and sends the encrypted command to the second intermediate processing device via the network.

7. A method for a mobile device to control a shipping peripheral device used for generating or printing postage, the peripheral device not being physically connected to the mobile device, the method comprising:
establishing, by the mobile device, a short range wireless communication with a first intermediate processing device coupled to a network;
sending, by the mobile device, a command to control the peripheral device to a first intermediate processing device via the short range wireless communication;
sending, by the first intermediate processing device, the command to a second intermediate processing device via the network, the second intermediate device having the peripheral device physically connected thereto, the second intermediate processing device storing a driver for the peripheral device; and
executing, by the peripheral device under control of the driver stored by second intermediate processing device, the command to perform a function associated with generating or printing of postage.

8. The method of claim 7, wherein the peripheral device is a scale.

9. The method of claim 7, wherein the peripheral device is a printer.

10. The method of claim 7, wherein the second intermediate processing device is coupled to the network by a wireless connection.

11. The method of claim 7, wherein the second intermediate processing device includes an indicator light that lights when the peripheral device is being operated.

12. The method of claim 1, further comprising:
encrypting, by the first intermediate processing device, the command; and
sending, by the first intermediate processing device, the encrypted command to the second intermediate processing device via the network.
